(19) United States
(12) Patent Application Publication
(10) Pub. No.: US 2016/0325576 A1
(43) Pub. Date: Nov. 10, 2016

(54) Two-Way Read-and-Show Illustrated Flip-Over Storytelling or Picture Books and Aids

(71) Applicant: Jehan Clements, Tarrytown, NY (US)

(72) Inventor: Jehan Clements, Peekskill, NY (US)

(21) Appl. No.: 15/055,276

(22) Filed: Feb. 26, 2016

Related U.S. Application Data
(63) Continuation-in-part of application No. 14/080,236, filed on Nov. 14, 2013, now abandoned.

(51) Int. Cl. B42D 1/00

(52) U.S. Cl. CPC B42D 1/009

(57) ABSTRACT

A selected number of pages are arranged in book-like fashion and bound together so that the book may be displayed with one hand under the back cover held by the instructor, storyteller or reader. The other hand is free to turn the pages and make reference to objects within the illustrations facing the audience. The back cover may be approximately horizontal to the floor. The pages facing the audience may be approximately perpendicular to the floor. The first story page facing the audience carries an illustration depicting a portion of the story, while the second story page facing the reader carries a mirror image of the illustration seen on the first story page along with the text that relates a portion of the story and both first and second story pages are in diametric contraposition to each other on separate and sequential pages bound with a horizontal spiral binding within the book.

### BACKGROUND OF THE INVENTION

This invention relates to improved illustrated books or aids, methods to create such illustrated books or aids, and publishing systems, including software programs and/or kits, to create such illustrated books or aids; and more particularly, to improved two-way illustrated flip-books or aids utilized by a person or persons to tell or relate a story to another person or group of persons, methods to create such two-way illustrated flip-books or aids, and systems, including software programs and/or kits, to create such two-way illustrated flip-books or aids.

Storytelling and reading facilitate teaching a child to recognize letters, words, objects, persons, places, colors, things and the like, and help the child learn to read themselves. Moreover, storytelling and reading help to develop the child's imagination. Thus books and other things may often combine graphic illustrations, in color in many instances, and related words to provide a more interesting experience for the young child.

Several types of illustrative text have been arranged in book-format. For example, test-type book formats utilizing flash card type arrangements are described in U.S. Pat. No. 4,950,167, entitled “Visual Detail Perception Test Kit and Methods of Use” (describing cards or large pages mounted in a loose-leaf type binder so that one viewer, in this case a tester, can utilize the indicia on one page while the other viewer, the testee, can utilize the indicia on the corresponding next, opposite, or facing page). Such book forms, however, are only used as a test kit, and do not show, teach or even suggest a story that is to be read by one party to another. Similarly, the Woodcock-Johnson Psycho-Educational Battery by Teaching Resources Corporation utilizes a bound book-type holder for successive cards or pages so as to present a first page with a graphic and a related but incomplete sentence to a test taker and a second page with a substantially identical graphic and the same incomplete sentence to a tester and with teaching aids on the testers page. This test kit is also a compilation of separate and distinct two-page sets—each presenting a test but not cooperating with each other to do any more than present separate and distinct test sets.

In addition, illustrated books or aids, methods to create such illustrated books or aids, and publishing systems, including software programs and/or kits, to produce such illustrated books or aids have been described. See, e.g., U.S. Pat. No. 5,713,743, entitled “Storytelling Flip Over Picture Book and Method of Providing and Presenting A Story;” U.S. Pat. No. 6,210,172, entitled “Do-It-Yourself Storytelling Book;” U.S. Patent Publication No. 2005/020386, entitled “Flip-Over Storytelling Book Publishing System, Method, and Kit.” While such patents and patent applications disclosed books or aids wherein the images or illustrations are on adjacent pages in the book in diametric contraposition to each other, the images or illustrations on both adjacent pages are identical to each other. Therefore, while the person or persons that tells or relates the story to another person or group of persons can read the story while the audience also views the image, it is difficult for that person or persons to point or otherwise refer or make reference to specific areas or objects within the images or illustrations without stopping to look at the page the audience is viewing, thereby disrupting the flow of the storytelling.

Thus, there exists a need for improved read-and-show illustrated flip-books and aids that can be utilized by a person or persons to tell or relate a story to another person or group of persons that are easier to simultaneous read and point or otherwise refer or make reference to specific areas or objects within the images or illustrations for the audience's benefit at the same time, methods to create such read-and-show illustrated flip-books, and systems, including software programs and/or kits, to produce such read-and-show illustrated flip-books. The present invention addresses this need.

### SUMMARY OF THE INVENTION

The present invention is a two-way storytelling or reading book or aid, wherein the book or aid is bound horizontally such that (1) at least one set of two separate and sequential adjacent leaves wherein page (a) comprising image or illustration (b) is on one leaf and page (a*) comprising image or illustration (b*) is on the other leaf; (2) the two pages (a) and (a*) on two separate and sequential adjacent leaves are in diametric contraposition to each other and with the binding on the top of the two separate and sequential adjacent leaves; and (3) the images or illustrations (b) and (b*) in pages (a) and (a*), respectively, on the two separate and sequential adjacent leaves are non-symmetrical images and illustrations and are mirror images of each other.

The present invention is also directed to methods to create such illustrated books or aids, for example by a parent, teacher, or child. Yet another aspect of the invention is directed to publishing systems for creating such illustrated books or aids. Such systems include a software program for generating from user input the adjacent pages (a) and (a*) that are in diametric contraposition to each other and wherein the images or illustrations (b) and (b*) on the adjacent pages are non-symmetrical images or illustrations and are mirror images of each other. Such systems optionally include a blank book that is composed, for example, of a front cover, a back cover, a binding, blank pages, and/or clear pocket-leaves for insertion of the pages generated by using the software program.

Other objects, features and advantages of the invention in its details of construction and arrangement of parts will be seen from the above, from the following description of the preferred embodiment and from the appended claims.

### BRIEF DESCRIPTION OF THE FIGURES

FIG. 1 depicts one aspect of the invention wherein one set of two adjacent pages (a) and (a*) in the book or aid are in diametric contraposition to each other and with the binding on the top of the two adjacent pages and the images or illustrations (b) and (b*) on the two adjacent pages are non-symmetrical images and illustrations and are mirror images of each other. In this particular embodiment, only the page to be viewed by the reader or instructor, page (a*), has text (c*) and image (b*), while the page to be viewed by the audience, page (a), has the image (b), but no text.

FIG. 2 depicts the problem with the prior two-way storytelling or reading book or aid described in U.S. Pat. No. 5,713,743, entitled “Storytelling Flip Over Picture Book and Method of Providing and Presenting A Story;” and U.S. Pat. No. 6,210,172, entitled “Do-It-Yourself Storytelling Book.” FIG. 3 depicts one aspect of the present invention, including how the present invention solves that problem.

FIG. 4 depicts one aspect of the invention, namely a kit to make a book or aid wherein one set of two adjacent pages (a) and (a*) in the book or aid are in diametric contraposition to each other and with the binding on the top of the two adjacent pages and the images or illustrations (b) and (b*) on the two adjacent pages are non-symmetrical images and illustrations and are mirror images of each other.

FIG. 5 depicts a view of the two-way storytelling or reading book or aid of the present invention from the perspective of the audience.

FIG. 6 depicts a view of the two-way storytelling or reading book or aid of the present invention from the perspective of the instructor, storyteller, or reader.

### DETAILED DESCRIPTION OF THE INVENTION

As used herein, the term “leaf” refers to a single sheet, of a material such as paper, having two sides. The term “page” refers to the subject matter printed, or to be printed, on one side of a leaf.

As used herein, the term “clear pocket-leaves” encompasses, but is not limited to, clear loose-leaf envelopes, clear loose-leaf page holders, clear plastic pocket pages, clear plastic sheet or page protectors, or other leaves having pockets, sleeves, slits, or envelopes suitable for holding leaves containing printed pages, such as the story pages described above.

As used herein, the term “blank book” encompasses, but is not limited to, a book consisting only of a front and back cover and a binding, or to a book including these elements as well as clear pocket leaves or paper that is suitable for affixing or inserting leaves containing printed pages on one or both sides, including essentially blank leaves of paper, or leaves of paper that are blank except with instructions on how to affix printed pages to the leaves to make the storytelling book or aid, e.g., instruction that essentially delineate where the printed pages are intended to be affixed in accordance with the present invention, wherein the instructions are optionally meant to be covered by the affixed printed pages. Accordingly, the storytelling book or aid can be created from a blank book by directly inserting or binding printed pages on leaves into the blank book in accordance with the present invention. Alternatively, the storytelling book or aid can be created from a blank book by inserting printed pages on leaves into the clear pocket-leaves in the blank book in accordance with the present invention. In yet another embodiment, the storytelling book or aid can be created from a blank book by printing pages and affixing the printed pages to blank leaves of paper in the blank book in accordance with the present invention, e.g., by gluing or taping the printed pages to the blank leaves of paper in accordance with the present invention, or affixing the printed pages to leaves of paper in the blank book with instructions for how to affix the printed pages to the leaves of paper in accordance with the present invention,

As used herein, the term “picture” encompasses any type of graphics or illustration, or other forms of visual media, which is preferably but not necessarily without words or printed text.

As used herein, the term “non-symmetrical” images and illustrations refers to images and illustrations that do not have reflection symmetry (sometimes referred to as line symmetry, mirror symmetry, or mirror-image symmetry). For example, graphic “b” is non-symmetrical if its mirror image “b*” is not identical or closely corresponding (e.g., of reduced or enlarged size) to “b.”

As used herein, the term “diametric contraposition” refers to two separate and sequential adjacent leaves that are bound together such that when both leaves are flat in an open-book formation (as opposed to a closed book formation where the leaves are flat and stacked on top of each other), the top of the leaves are bound together and the bottom of the leaves are on opposite ends and are spatially furthest apart.

One embodiment of the present invention is a two-way storytelling or reading book, wherein the book is bound horizontally such that (1) at least one set of two separate and sequential adjacent leaves wherein page (a) comprising image or illustration (b) is on one leaf and page (a*) comprising image or illustration (b*) is on the other leaf; (2) the two pages (a) and (a*) on two separate and sequential adjacent leaves are in diametric contraposition to each other and with the binding on the top of the two separate and sequential adjacent leaves; and (3) the images or illustrations (b) and (b*) in pages (a) and (a*), respectively, on the two separate and sequential adjacent leaves are non-symmetrical images and illustrations and are mirror images of each other. When a reader is reading the book to an audience, page (a)—on the top side of the book—can be viewed by the audience while page (a*)—on the bottom side of the book—is being simultaneously viewed by the reader.

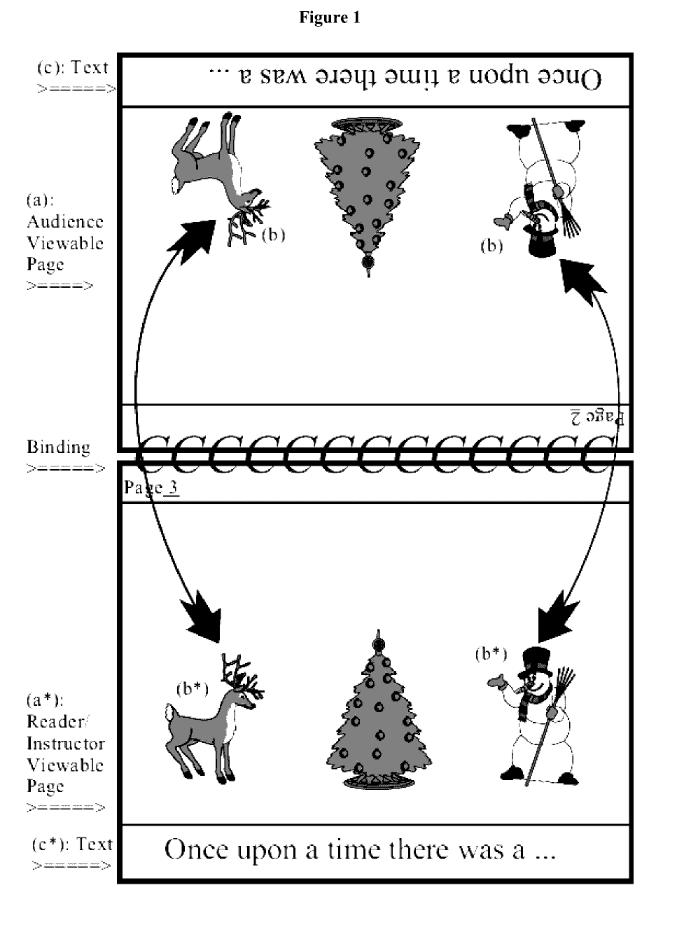

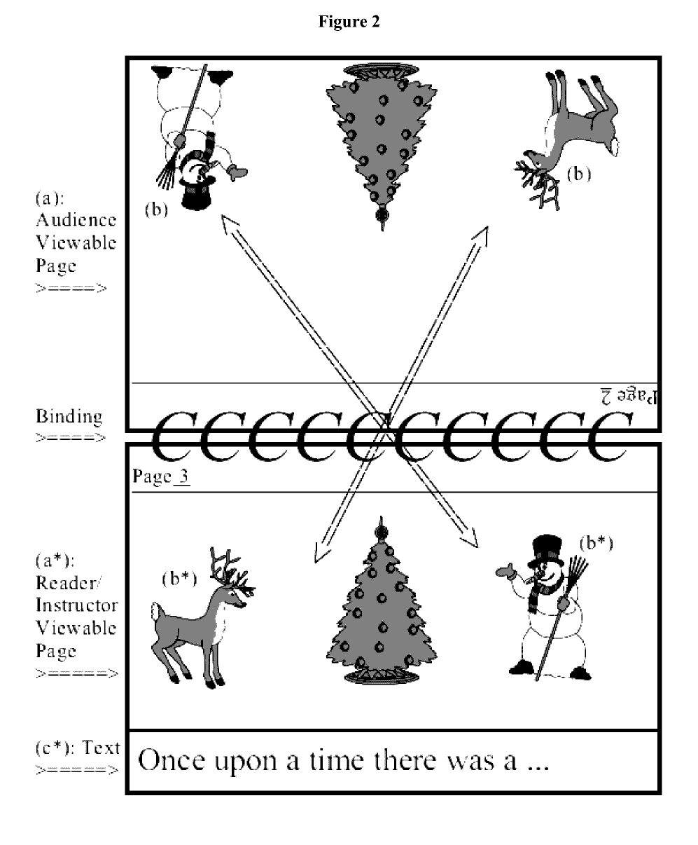

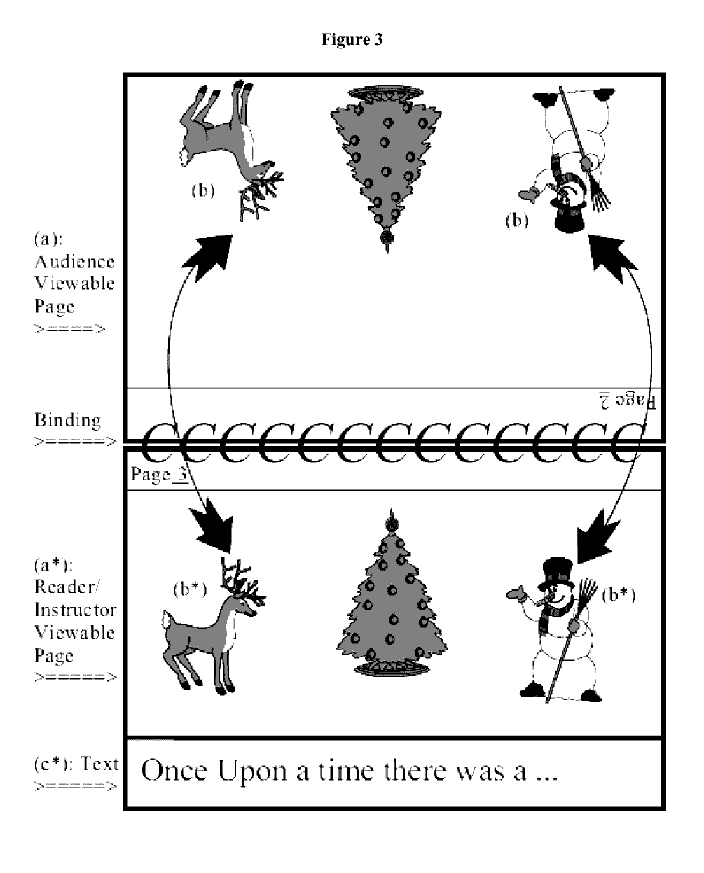

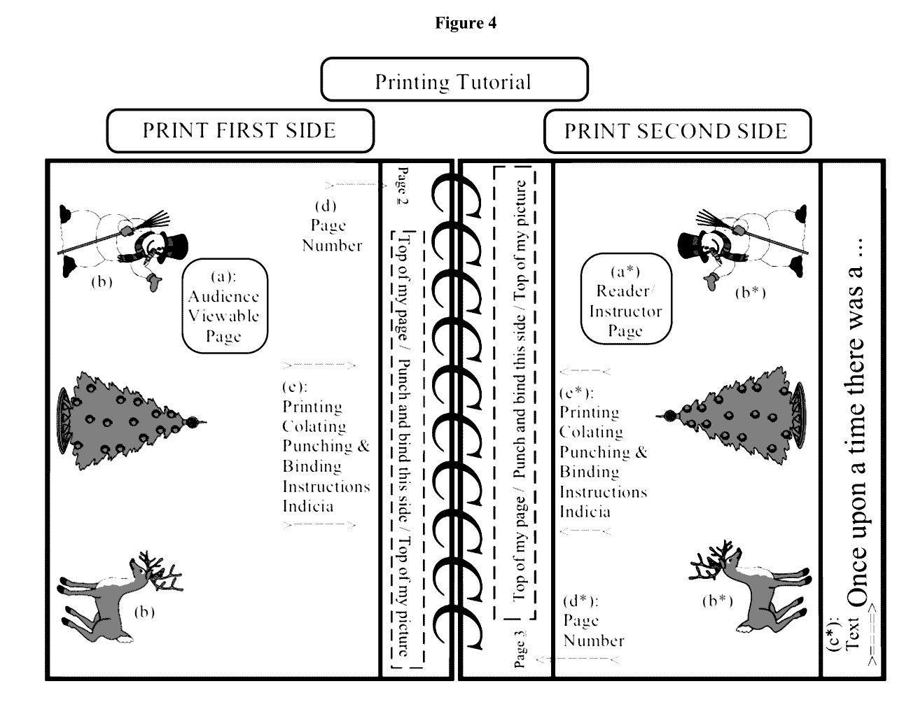

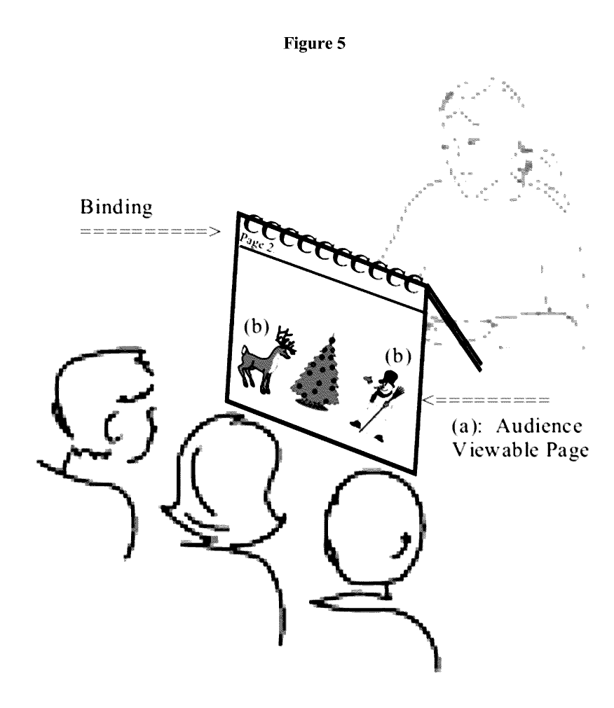

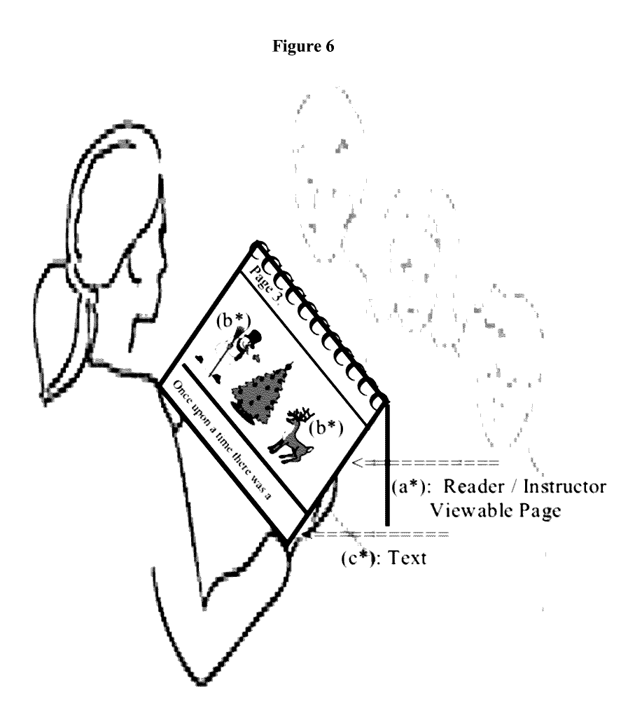

Another embodiment of the present invention is a two-way storytelling or reading aid, wherein the aid is bound horizontally such that (1) at least one set of two separate and sequential adjacent leaves wherein page (a) comprising image or illustration (b) is on one leaf and page (a*) comprising image or illustration (b*) is on the other leaf; (2) the two pages (a) and (a*) on two separate and sequential adjacent leaves are in diametric contraposition to each other and with the binding on the top of the two separate and sequential adjacent leaves; and (3) the images or illustrations (b) and (b*) in pages (a) and (a*), respectively, on the two separate and sequential adjacent leaves are non-symmetrical images and illustrations and are mirror images of each other. When an instructor is using the aid to instruct an audience, page (a)—on the top side of, for example, FIG. 1—can be viewed by the audience while page (a*)—on the bottom side of, for example, FIG. 1—is being simultaneously viewed by the instructor.

In one preferred embodiment of the invention, page (a) on one leaf has text (c) to accompany image or illustration (b) and page (a*) on the separate and sequential adjacent leaf has text (c*) to accompany image or illustration ((b*). In another preferred embodiment of the invention, only the page to be viewed by the reader or instructor, page (a*), has image (b*) and text (c*), while the page to be viewed by the audience, page (a), has only image (b), and no text (c). In another preferred embodiment of the invention, pages (a) and (a*) on separate and sequential adjacent leaves have images (b) and (b*), respectively, but no text (c) or (c*).

In one embodiment of the invention, the image or illustration (b) in page (a) on one leaf and the image or illustration (b*) in page (a*) on the separate and sequential adjacent leaf are the same size. In another embodiment of the invention, the image or illustration (b) in page (a) on one leaf is larger than (b*) in page (a*) on the separate and sequential adjacent leaf.

In one embodiment of the invention, such books or aids are wire, spiral or loose-leaf bound. It should be understood, nevertheless, that other forms of reproduction of the graphics and text besides printing may be utilized, that the book may be bound together by wire, plastic, rings or other suitable and appropriate means that facilitate turning of the pages and that the book may be utilized with page (a*) being held relatively flat by the reader or instructor (i.e., about parallel with the floor), for example held in the reader's or instructor's hand or placed on the reader's or instructor's lap, while the audience simultaneously views page (a).

In another aspect of the invention, the books or aids are children's books. In one aspect of the invention, the books or aids are pictoral books. In another aspect of the invention, the books or aids are fictional, such as fables or storybooks. In another aspect of the invention, the books or aids are nonfictional, such as textbooks, science books, history books, or social studies books.

The storytelling book or aid can be displayed by a reader or instructor by holding the storytelling book or aid in one hand such that the other hand is free to point or otherwise refer or make reference to specific areas or objects within the images or illustrations or the text on the page to be viewed by the audience, i.e., to the image or illustration (b) or to text (c) in page (a), or aspects thereof, while the reader or instructor is simultaneously reading or otherwise referring to the page to be viewed by the readier or instructor, i.e., to the image or illustration (b*) or to text (c*) in page (a*) without the reader or instructor also having to directly look at page (a). Alternatively, the storytelling book or aid can be displayed in a flat configuration, e.g., in the lap of the instructor, storyteller, or reader, or in an easel-like configuration.

In one aspect of the invention, the book or aid has a plurality of leaves or pages numbered 1-11, etc., conventionally bound together as by conventional plastic and/or metal loops carried by a spine and in a manner that facilitates reading pages 3, 5, 7, 9, 11, etc., to an audience while the audience is simultaneously viewing pages 2, 4, 6, 8, 10, etc. A front cover and a back cover may be provided for the storytelling book or aid. The covers may be of the same stock as that of pages 1-11, etc., or of different stock and may be of the same size as pages 1-11, etc., or slightly larger as conventionally done for many books. Alternatively, the back cover may be of a heavier stock than that of the front cover and of pages 1-11, etc.

Another embodiment of the present invention is a method to create such illustrated books or aids, for example by a parent, teacher, or child. Yet another aspect of the invention is directed to publishing systems for creating such illustrated books or aids. Such systems include a software program for generating from user input pages (a) and (a*) that are to be placed on the separate and sequential adjacent leaves that are in diametric contraposition to each other and wherein the images or illustrations (b) and (b*) in pages (a) and (a*), respectively, on the separate and sequential adjacent leaves are non-symmetrical images and illustrations and are mirror images of each other. Such systems can optionally also include a blank book that is composed, for example, of a front cover, a back cover, a binding, as well as optionally blank leaves, leaves with instructions on how to affix the printed pages generated by using the software program and/or clear pocket-leaves for insertion of the printed pages generated by using the software program.

The following non-limiting examples will illustrate in more detail the various aspects of the present invention.

### Example 1

A storytelling book is bound by a plasticor metal coil, spiral spine or a plastic comb spine to facilitate the easy turning of the leaves of the bookor the standing up of the book in easel-like configuration and also to facilitate reading and telling of the story and use of the book.

The storytelling book has leaves with pages having consecutive page numbers 2-13, etc., wherein a set of pages with even page numbers, i.e., pages 2, 4, 6, 8, 10, 12, etc., are intended for viewing by the audience (“audience-facing pages”), and the corresponding set of pages with odd page numbers, i.e., pages 3, 5, 7, 9, 11, 13, etc., are intended for viewing by the instructor, storyteller, or reader (“reader-facing pages”). Each leaf with an audience-facing page (with even page number) has a corresponding separate and sequential adjacent leaf comprising a reader-facing page (with odd page numbers), wherein any image or illustration in the audience-facing page is a mirror image of an image or illustration in the reader-facing page, and wherein the image or illustration in the audience-facing page and the image or illustration in the reader-facing page are in diametric composition to each other. Some or all of the audience facing pages are “a” pages of the present invention, and include non-symmetrical images or illustrations “b,” illustrating a portion of a story or material to be discussed. Each leaf in the storytelling book that comprises an audience-facing “a” page (with an even page number) with a non-symmetrical image or illustration “b” has a corresponding, separate and sequential adjacent leaf with a reader-facing “a*” page (with an odd page number) with an image or illustration, “b*” that is a mirror image of “b” and is not identical or closely corresponding (e.g., of reduced or enlarged size), to “b.”. Therefore, the audience-facing pages (with even page numbers), including the “a” pages with non-symmetrical “b” images or illustrations, depict the intended story or materials to be discussed and do so in successive panels in the sequence of the story to be told or materials to be discussed. Likewise, the reader-facing pages (with odd page numbers), including the “a*” pages with “b*” images or illustrations that are mirror images of “b” and are not identical or closely corresponding (e.g., of reduced or enlarged size) to “b,” depict the intended story or materials to be discussed and do so in successive panels in the sequence of the story to be told or materials to be discussed, In other words, the set of audience-facing pages successively illustrate the story or material to be discussed; likewise, the corresponding set of reader-facing pages with odd page numbers also successively illustrate the story or material to be discussed.

In addition, the images or illustrations “b*” in the reader-facing “a*” pages (with odd page numbers) can be the same size or of a proportionally reduced size to the images or illustrations “b” in the audience facing “a” pages (with even page numbers). For example, the graphic “b*” on page 15 is a mirror image of the image or illustration “b” on page 14, but “b*” on page 15 is not identical, or closely corresponding (e.g., of reduced or enlarged size), to “b” on page 14, and “b” and “b*” are of the same size. In another example, the graphic “b*” on page 17 is a mirror image of graphic “b” on page 16, but not identical, or closely corresponding (e.g., of reduced or enlarged size), to the graphic “b” on page 17, and b* on page 17 is of a reduced size and the graphic “b” of page 16.

The images or illustrations on the audience-facing pages (with even page numbers), including the non-symmetrical “b” images and illustrations in the “a” pages, are preferably sized to encompass substantially the entire leaf and are preferably in color but may be in black and white, or otherwise.

In one example, some or all of the audience facing pages (with even page numbers), including the “a” pages, do not have any text. In another example, some or all of the audience facing pages (with even page numbers), including the “a” pages, have “c” text, and the corresponding reader-facing pages (with odd page numbers), including the corresponding “a*” pages, have corresponding “c*” text. In yet another example, the reader-facing pages (with odd page numbers), including the “a*” pages, have “c*” text that is not in the corresponding audience-facing page. In certain embodiments, the “c*” text in the reader-facing page may constitute the portion of the story corresponding to the corresponding images or illustrations on the reader-facing page, including the non-symmetrical “b*” image or illustration in the “a*” page. For example, the “c*” text on page 19 corresponds and relates to the images or illustrations (b) and (b*) on pages 18 and 19, respectively. In one example of the invention, the “c*” text is displayed above or below the “b*” images or illustrations in the “a*” pages (with odd page numbers). In certain other embodiments, the “c*” text may include questions for the audience pertinent to the story line or other pertinent material or information to assist the instructor, storyteller, or reader, which optionally is not intended to be seen by the audience. In addition, additional leaves with pages with other information, textual material, questions, hints, aids and the like may be included and therefore may be bound into the storytelling book or aid.

In use, the instructor, storyteller, or reader can hold part of the storytelling book, including at least the back cover of the storytelling book, in one hand such that the audience-facing pages, including the “a” pages (with even page numbers), can be viewed by the audience, and the reader-facing pages, including the “a*” (with odd page numbers) can be viewed simultaneously by the instructor, storyteller, or reader. The other hand of the instructor, storyteller, or reader is free to flip the leaves comprising the reader-facing pages, including the “a*” pages (with odd page numbers) over the binding to progress to the next portion of the story or material to be discussed. For example, the instructor, storyteller, or reader can starting at the beginning of the story or material to be discussed, e.g., page 2, with the “b” graphic and optional “c” text on page 2 facing the audience and the “b*” graphic on page 3 and optional “c*” text facing the instructor, storyteller, or reader. The “b” graphic on page 2 is a mirror image that is not identical, or closely corresponding (e.g., of reduced or enlarged size), of the “b*” graphic on page 3. After completing reading and/or discussing page 3 (and easily pointing and/or referring or making reference to the “b” graphic, and optional “c” text, on page 2 without looking directly at page 2, and asking any questions, etc.), the instructor, storyteller, or reader can then proceed to turn the page, resulting in page 4 facing the audience and page 5 facing the reader. Again, the reader or instructor can read page 5 and seamlessly point and/or refer or make reference to any relevant “b” graphic or optional “c” text within page 4 without looking away from page 5 based on the “b*” graphic and optional “c*” text on page 5. In this way, the reader and the audience can each see the material on the page sides facing of them in the proper orientation for reader and viewing, respectively, i.e., the reader and audience pages are in ‘diametric contraposition’ to each other. And, because the images and illustrations are mirror images of each other, the reader or instructor does not need to look at the audience's page to properly locate and point and/or refer or make reference to the images and illustration within the audience's page. The instructor, storyteller, or reader thus continues until the story and related questions and other text material are finished. In another embodiment of the invention, the storytelling book or aid may be used in an easel-like confirmation as described above, but with the book or aid standing like an easel on a flat surface, like a table or the floor, instead of held in one hand.

Alternatively, the storytelling book or aid may be used by holding the book or aid on the lap of the reader, with the back cover and the reader-facing pages (with odd page numbers), including the “a*” pages, sitting on the lap facing up for reading and the audience facing pages (with even page numbers), including the “a” pages, hanging down over the knees of the reader and thus facing the audience. In yet another embodiment of the invention, the storytelling book or aid may be used as described above but with its pages flat on a surface (like a table) instead of on the lap of the reader.

From the above description it will thus be seen that there has been described a new and improved storytelling book or aid which permits the instructor, storyteller, or reader to present a story or material to be discussed while the audience observes the graphic illustrations of each successive portion of a story or material in a way that facilitates interactions with the audience and the page the audience is viewing.

### Example 2

In an alternate example, the “c” text and corresponding non-symmetrical “b” pictures in the audience-facing “a” pages (with even page numbers) from a story are in close proximity on the same page, so that an audience of listeners may see the “b” picture and the “c” text while the storyteller is reading the corresponding “c*” text in the reader-facing pages “a*” on the separate and sequential adjacent leaf. In one embodiment, the “c” text is identical to, or related to, the “c*” text being read out loud to them by a reader. In this example, the textural material is disposed across page 20 with a non-symmetrical “b” graphic and “c” text facing the audience and page 21 having a graphic “b*” and “c*” text facing the reader. The “b*” graphic on page 21 is a mirror image of the “b” graphic on page 20 and is not identical, or closely corresponding (e.g., of reduced or enlarged size), to the “b” graphic. The “c” text on page 20 corresponds to the “c*” text on page 21. Any combination of pictures and text on the page facing the audience is within the scope of the present invention so long as the images or illustrations (b) and (b*) are non-symmetrical images or illustrations and are mirror images of each other and are not identical, or closely corresponding (e.g., of reduced or enlarged size), to each other. The “c” text on the audience-facing pages (with even page numbers), including the “a” pages, may, but need not, be identical to the “c*” text on the reader-facing pages (with odd page numbers), including the “a*” pages, on the corresponding separate and sequential adjacent leaves. Similarly, the “b” pictures on the audience-facing pages (with even page numbers), including the “a” pages, may, but need not, be of larger size than the “b*” pictures on the reader-facing pages (with odd page numbers), including the “a*” pages, on the corresponding separate and sequential adjacent leaves.

### Example 3

In another example, a person, preferably a child, creates his or her own story and relates that story to an audience. In one embodiment, the storytelling book is a teacher's aid especially designed for use in a classroom by students, when they are producing a single copy of an original story. The storytelling book of the present invention adapted for use with this educational technique facilitates the educational process of writing, illustrating, designing, and then reading out loud a story created by the student. In another embodiment, the storytelling book is a project a child can complete at home with a parent or guardian.

In such a storytelling book, rather than permanent pages, a kit is provided with a blank book, for example a binder with clear pocket leaves, to hold original insertion pages created by the child. These blank books can be of any design (e.g., books with substantially clear loose-leaf envelopes open at the edges perpendicular to loops or even a blank surface directly bound by loops to which the insertion pages can be affixed), so long as the original and corresponding insertion pages comprising images or illustrations that are non-symmetrical mirror images of each other (created as described below) can be inserted or affixed into the blank book such that the original and corresponding insertion pages on separate and sequential adjacent leaves are in diametric contraposition to each other. The clear loose-leaf page holders may contain a stiff opaque insert to maintain their shape and provide a background for the insertion pages, as described below.

### Example 4

The computer software program of the present invention provides users, such as students in a school, with a graphical presentation on the computer screen to assist such users in writing and illustrating a story of their own creation in the form of a flip-over diametric contraposition storytelling book. The software program may also be used in a home schooling environment with a personal computer and printer.

To begin, the software program provides a book cover in landscape view for the user to work with. The book cover may be further designed and customized with the use of backgrounds and clip art, so that it relates to the title and subject of the story created by the user.

After the front cover is designed, the software program produces another page in landscape view with the name of the book, the title of the story, and the name of the user. The “Rights” information optionally automatically appears at the bottom of this page, which is the reverse side of the front cover.

After the title, and optional “Rights” page is designed, the software program provides a blank story screen in landscape view. The user creates art work using clip art or other graphics, and writes text for the story in each successive blank story screen. An unlimited number of blank story screens are provided by the software program until the story is completed by the user. It is possible for the user to return to the book cover, or any of the subsequent pages, to make changes to the art work and/or the words as many times as necessary. After the story is completed, the software program presents a slide show of all the pages of the story in succession. The story will be presented on the screen so the user has a more complete view of the story, and evaluate whether further changes are needed.

After the user completes the design of the story pages, the software program automatically produces an additional page that is separate and sequential to each story page created by the user (“original page”) such that the image on the additional page generated by the software program is a mirror image of the image created by the user on the original page (for all non-symmetrical images created by the user, the program generated mirror image is not be identical or closely corresponding (e.g., of reduced size) to the original image created by the user). Both pages—the original page and the additional page generated by the software program—are displayed on the screen. The software program would allow the user to edit the text in both the original page and the additional page generated by the software program. Again, it is possible for the user to return to the book cover, or any of the subsequent pages, to make changes to the art work and/or the words as many times as necessary.

As an example, the software program can display the original page and the separate and sequential adjacent additional page generated by the software program, e.g., pages 2 and 3 of the user's story, on the screen at the same time to more fully demonstrate their diametric contraposition relationship to each other.

The software program optionally automatically produces and displays on the top side edge of the pages, information and instructions as to which side edge of the printed pages are to be punched and bound to form a flip-over storytelling book.

When the final version of the story is completed, the software program may display a tutorial, such as a video presentation, to teach the user how to print out the pages of the story. Using a printer connected to the computer, the user is given instructions how to print both sets of pages corresponding to each side of the leaves of the book. The software program may provide further instructions to the user as to how to punch and bind the front cover, the reverse side of the front cover, as well as the inside leaves, and then bind the blank back cover together with a horizontal binding, such as a spiral binding. The software program automatically orients the pages of the book so that the pages that the audience would see, as well as the pages that the user would read from in the completed book, are displayed in diametric contraposition to each other within the book.

The storytelling book publisher software program provides the user with tools to create an entire flip-over storytelling book. The front cover and all of the inside pages are created page-by-page on the computer screen, without the use of paper, until the user is ready to print out the book. Assuming that the final book is page-numbered sequentially, the user thus creates, for example, all of the odd-numbered pages of the story, and the software program automatically produces the corresponding even-numbered pages of the story.

### Example 5

In the example described below, the pages in the storytelling book are sequentially numbered. When the user/reader presents the story to an audience, the user reads from pages 3, 5, 7, 9, etc. and the audience will see the corresponding separate and sequential adjacent pages 2, 4, 6, 8, etc. at the same time. Pages 2 and 3, 4 and 5, 6 and 7, 8 and 9, etc. will be oriented in diametric contraposition to each other within the book and the non-symmetrical images on pages 2 and 3, 4 and 5, 6 and 7, 8 and 9, etc. will be mirror images of each other and will not be identical or closing corresponding (e.g., of reduced size) to each other. In this example, the odd-numbered pages are created by the user, and the even-numbered pages are automatically produced by the software such that the images on the pages produced by the software are mirror images of the images on the pages created by the user. As long as a second set of pages (which alternate with the user-generated pages in a completed flip-over storytelling book) is automatically generated by the software, it does not matter how, or whether, the pages are numbered.

A cover page, supplied by the storytelling book publisher software program. On the screen there is a story screen page in the landscape mode with text boxes for the user to type in the author's name and the title of the story. The user may, for example, change the color of the background and/or paste or generate art onto the cover page that relates to the title and subject of the story.

The reverse side of the cover page is automatically produced by the storytelling book publisher software program when the user clicks on the “Finished” button located at the bottom of the front cover page screen. This page will then be displayed on the screen in landscape mode and will show the name of the book, the name of the user and the title of the story. The “Rights” information optionally can be included at the bottom of the reverse side of the front cover page.

The front cover of the book and the reverse side of the cover may be printed separately from the inside pages. For example, one piece of glossy photo paper is placed into the feeder tray of the printer. By clicking on the “Print” button, the printer prints the cover page on the glossy side. By simply turning the page over and placing it back into the feeder tray in the same direction that it came out of the printer, and clicking on the “Print” button, the printer prints the back of the cover page on the matte finish side.

The binding edge of the cover and the binding edge of the reverse side of the cover are punched on the same top edge. The software program automatically orients the reverse side of the cover so that it appears right-side-up to the audience when the user reads the book aloud to an audience.

The software program automatically produces another title page for the book. This page would be “page 1” of the inside pages of the book. This page contains the name of the book, the title of the story, and the name of the user. The software program automatically produces the “Rights” information at the bottom of this page.

The software program optionally also produces indicia, such as page numbers and/or binding instructions, on page 1 of the book.

A blank story screen for an odd-numbered page will appear when the user clicks on the “Finished” button on the screen at the bottom of the page. The user will begin the story by typing in the text box, or begin by pasting art into the picture box displayed within the story screen produced by the software program. The user clicks on the “Finished” button to move to the next page.

The text box provided by the software program contains, or operatively relies on, a word processing program. Using the “Text Format” buttons in the tool bar, the user will be able to format, for example, the font, style, size, color, and justification of the words of the story.

Clip art that the user may use to illustrate the story may be stored within the computer. For example, the clip art may be downloaded as part of the installation of the software program on the computer. The user may have access to different backgrounds to give an environment for the story. The user may paste clip art of objects, plants, animals, and people into the picture box within the story screen to illustrate a portion of the story. As an alternative, the software program may have drawing tool buttons for preparing original artwork for the user's story.

By clicking on the “Finished” button, the software program allows the user to move onto the next odd-numbered page in the book. The software program then provides a blank story screen for the next odd-numbered page. The user will continue to create the story, by typing words into the text box and adding art into the picture box of the story screen.

In one example, the software program automatically produces indicia, such as page numbers and binding instructions, on the story pages of the book. In another example, the software program does not produce such indicia.

The user continues to write words and create illustrations for the story on the odd-numbered pages, and the software program continues to provide blank story screens until the user is finished with the story. By using the “Edit My Story”, “Back”, and “Next” buttons, the user is able to navigate through the story, and return to the cover or any of the inside story pages to make as many changes as necessary.

When the user is completely finished with the story, the user may click on the “Publish My Story” or “Slide Show” buttons. The “Publish My Story” button causes all of the pages to appear on the screen at the same time in thumbnail images. The “Slide Show” button causes all of the pages to be displayed on the screen one after another. The user will be able to navigate through the pages by using the “Back” and “Next” buttons on the screen. The “Publish My Story” and “Slide Show” presentations may be played as many times as necessary. This step is designed to provide the user with an overview of the entire story, without interruption, so an extra evaluation may be made. These two features will allow any user to read the story aloud off of the screen, but not make any changes to the illustrations or words.

The “Edit My Story” button may require the use of a password created by the original author/illustrator user. By clicking on the “Edit My Story” button, the software program takes the user to the front cover of the book. The user may make changes to the front cover (these changes, if they apply, will automatically be made by the software program to the reverse side of the front cover, and the first inside page of the book) and to any of the relevant inside pages of the book.

The software program will then display a tutorial, such as a video, to teach the user how the pages of the story will appear in the book. For example, pages 2 and 3 will appear on the screen at the same time. Page 3 (and all odd-numbered pages) will have been created by the user as part of the input steps described above. Corresponding separate and adjacent page 2 (and all even-numbered pages) is automatically produced by the software program such that the images or illustrations are mirror images of the non-symmetrical images or illustration on page 3 (and all corresponding odd-numbered pages). In a “story reading” version, if page 3 has text, the software can generate the same text from page 3 onto page 2. In a “storytelling” version, the software does not generate all or any of text to be placed onto page 2. In both versions, the even-numbered pages may include an enlarged or enhanced version of the text or the non-symmetrical images on the odd-numbered pages.

In one example, the software program displays the corresponding separate and sequential adjacent pages, e.g., pages 2 and 3, vertically on the screen in diametric contraposition to each other. The software program may have a feature to change the display orientation of the user's corresponding separate and sequential adjacent pages that will be in diametric contraposition to each other, or alternative, that each page, e.g., page 2 or page 3, will be displayed separately. A “Full View” button feature in a “View” drop down menu in a tool bar on the page screen could show pages 2-3, 4-5, 6-7, 8-9, etc. on the screen at the same time vertically and in diametric contraposition to each other.

In one example, the software program will automatically produce and display orientation indicia, such as page number and binding instructions, on the pages. These indicia will instruct the user as to which side edge of each page is to be punched and bound together, in diametric contraposition to each other. The indicia included on the printed pages are intended to help the user to orient the printed pages of the book into their proper order and in proper diametric contraposition to each other, for example to help the user with a first book created by the software. Accordingly, these indicia may include symbols or written instructions and applied to the printed pages, with the leaves and pages punched and bound between the front and back cover of a blank book, or for orienting the printed pages in relationship to corresponding indicia on blank leaves or clear pocket-leaves that will hold the printed leaves in place between the front and back cover of a book. For example, the printed pages may include dots printed in an appropriate corner, that would correspond to rings printed on blank book pages. This method would allow a user to quickly assemble a storytelling book in diametric contraposition form without the need to read written instructions.

As an alternative, the instructions for where to punch and bind the top side edge of all the pages will appear only on the top side edge of page 1, as all the other pages underneath may be in their correct position and orientation as they come out from the printer. This method may be used after the user becomes familiar with the concept of diametric contraposition. As yet another alternative, the software program will not automatically produce and display orientation indicia, such as binding instructions, on the pages.

When the user is ready to print the story, the user will click on the “Print My Book” button. Continuing the example numbering scheme described above, stories created with the software program will end with an odd page number. The software program may automatically produce an additional even-numbered page (e.g., with “The End” printed on it), which will be oriented for display to the audience during the reading of the story. This additional even numbered page with “The End” printed on it will give the user, the software program and the printer a point of reference during the process of printing the inside pages of the book.

The book may be produced in the portrait mode rather than the landscape mode, but still having all the pages in diametric contraposition to each other.

Once printed, the pages for the reader and the audience will be bound together with a horizontal binding, such as a spiral binding. The cover and inside pages will be in diametric contraposition to each other within the book. The back cover is preferably of heavier stock than the inside pages. The author/illustrator user is now ready to read the flip-over storytelling book aloud to an audience.

### Example 6

The following steps are to be followed if the user is using a printer that prints a single page (i.e., a single side of a leaf) at one time. The software program will display a video to teach the user how to work with the paper and the printer, and how the pictures and words for the story will be printed on both sides of the leaves of paper.

When the user clicks on the “Print First Side” button, all of the even-numbered pages will be printed out, for example in reverse order. The user will then take all of the pages, and turn them over, and place the pages back in the feeder tray in the same direction that they came out of the printer.

When the user clicks on the “Print Second Side” button, all of the odd-numbered pages will be printed out in the same order, for example reverse order. The user will then put the cover on top of the pile of the inside pages that are in their correct order and correct orientation, and take them to the punching and binding machine. The book cover and the inside pages may be punched and then bound together with a pre-punched blank back cover, wherein the back cover is preferably of heavier stock than the inside pages.

Alternatively, the user's story may be printed on both sides of the leaves as part of a single operation of a printer. By making use of a printer that prints on both sides of the paper at the same time (e.g., by printing one side and then the other before the leaf comes out of the printer), the pages may be automatically printed in diametric contraposition format.

### Example 7

Another example of the present invention is a kit that includes the software program described above and a blank book for inserting pages in diametric contraposition to each other may be provided as a kit. A user may produce flip-over book pages using the software program described above and then insert them into a blank book supplied as part of the kit.

It is understood that although there has been shown and described a preferred embodiment of the invention that various modifications may be made in the details thereof without departing from the spirit as comprehended by the following claims.

I claim:

1. A two-way read-and-show illustrated flip-over storytelling or picture book or aid, wherein the book or aid is bound horizontally with a binding and comprises
(1) at least one set of two adjacent pages, a first page and a second page, on two separate and sequential adjacent leaves, a first leaf and a second leaf, that are in diametric contraposition to each other and bound such that the binding is on a top edge of the first leaf containing the first page and the second leaf containing the second page; and
(2) a first non-symmetrical image or illustration—in the first page on the first leaf and a second non-symmetrical image or illustration in the second page on the second leaf are mirror images of each other.

2. The book or aid of claim 1, wherein for at least one set of adjacent pages—the first page has accompanying text and the second page has the same accompanying text.

3. The book or aid of claim 1, wherein for at least one set of adjacent pages the first page has the first non-symmetrical image or illustration and has accompanying text and the second page has the second non-symmetrical image or illustration and does not have accompanying text

4. The book or aid of claim 1, wherein for at least one set of adjacent pages the first page has the first non-symmetrical image or illustration and does not have accompanying text and the second page has the second non-symmetrical image or illustration and does not have accompanying text.

5. The book or aid of claim 1, wherein for at least one set of adjacent pages the first non-symmetrical images or illustration and the second non-symmetrical image or illustration are the same size.

6. The book or aid of claim 1, wherein for at least one set of adjacent pages. the first non-symmetrical image or illustration is larger than the second non-symmetrical image or illustration.

7. The book or aid of claim 1 is selected from the group consisting of children's books, pictorial books, fictional books, fables, storybooks, nonfictional books, textbooks, science books, history books, and social studies books.

8. A kit for creating a book or aid wherein the book or aid is bound horizontally with a binding and comprises
(1) at least one set of two adjacent pages, a first page and a second page, on two separate and sequential adjacent leaves, a first leaf and a second leaf, in the book or aid that are in diametric contraposition to each other and bound such that the binding is on a top edge of the first leaf containing the first page and the second leaf containing the second page; and
(2) a first non-symmetrical image or illustration in the first page on the first leaf and a second non-symmetrical image or illustration in the second page on the second leaf are mirror images of each other;
comprising
a book publishing system to produce from user input at least one set of first pages with the first non-symmetrical image and illustration and second pages with the second non-symmetrical image or illustration, wherein the first non-symmetrical image or illustration in the first page and a second non-symmetrical image or illustration in the second page are mirror images of each other; and
a blank book that comprises a front cover, a back cover, a binding, blank leaves, and/or pocket-leaves for insertion of the pages produced by using the software program.

9. The kit of claim, wherein the book publishing system automatically produces the first pages with the first non-symmetrical image or illustration to be mirror images of the second pages with the second non-symmetrical images or illustrations created from user input.

10. The kit of claim, wherein the book publishing system automatically produces the second pages with the second non-symmetrical images or illustrations to be mirror images of the first pages with the first non-symmetrical images or illustrations created from user input.
